(19) United States
(12) Patent Application Publication
(10) Pub. No.: US 2013/0169425 A1
(43) Pub. Date: Jul. 4, 2013

(54) BLIND SPOT WARNING DEVICE AND BLIND SPOT WARNING SYSTEM

(71) Applicants: Trent Victor, Vastra Frolunda (SE); Pontus Larsson, Molndal (SE)

(72) Inventors: Trent Victor, Vastra Frolunda (SE); Pontus Larsson, Molndal (SE)

(73) Assignee: Volvo Technology Corporation, Goteboreg (SE)

(21) Appl. No.: 13/522,975

(22) PCT Filed: Jan. 19, 2011
(86) PCT No.: PCT/SE2011/000006

§ 371 Date: Sep. 12, 2012

(30) Foreign Application Priority Data
Jan. 19, 2010 (SE) 1000051-1
Jan. 19, 2010 (SE) 1000927-2
Jan. 19, 2010 (SE) 1000928-0

(51) Int. Cl. B60Q 9/00

(52) U.S. Cl. CPC B60Q 9/008
USPC 340/435

(57) ABSTRACT

A blind spot warning device is attachable to a host vehicle's exterior and includes a warning indicating at least one blind spot of the host vehicle to a target object being outside the host vehicle, wherein the warning is only perceptible for the target object in dependence on the target object's relative position to the host vehicle. Further, a blind spot detection system is disclosed, along with a vehicle including such a blind spot warning device and/or such a blind spot detection system.

### BACKGROUND AND SUMMARY

The present invention relates to a blind spot warning device and a blind spot warning system for a host vehicle, and a vehicle comprising the same.

Many traffic accidents are related to the limited field-of-view of the driver and the so-called blind spot areas around vehicles. Considering e.g. heavy trucks, there are large blind spots all around the vehicle, but the problem exists also for other vehicles such as passenger cars, buses or construction equipment. Examples of traffic situations where the limited field-of-view of a truck can result in hazardous situations are:

Lane changes and turns towards the passenger side,

Starting from stationary at zebra crossings and other situations where a road user may be in front of the vehicle,

Back-up situations e.g. when ranging up to a loading dock.

While additional mirrors can increase the driver's field of view, this solution can have negative aerodynamic effects and also increase the complexity of the driver interface. Moreover, mirrors are difficult to adjust and wide angle mirrors provide only distorted views of the surrounding traffic.

Active systems which detect and warn the driver for objects present in the blind spots may be another solution to the problem. However, this still does not solve the key problem which in many blind spot accidents is that the person in the blind spot (target object) is not aware of that he/she cannot be seen by the driver (host). It should be noted that in the following “target object” or “target” can be any other road user such as another vehicle, a cyclist or a pedestrian. If a target object knows that he is in the blind spot of a vehicle, the blind spot is easy to avoid, e.g. simply by passing the host vehicle or letting the host vehicle pass. However, what is more difficult is realizing that one is in a blind spot.

It has therefore been suggested in the state of the art to inform the target that he/she is in the blind spot. According to patent application US 2006/082908, this can be done by attaching blind spot warning decals to strategic areas of the truck. For informing the target where the blind spot zone begins and ends, it is further suggested by this state of the art to arrange reflectors at both sides of the decal which are intended to indicate begin and end of the blind spot zone.

Disadvantageously, a target cannot really estimate by the

arrangement of the reflectors alone whether he is in the blind spot or not. Therefore, a target cannot intuitively understand where the blind spot zone begins and ends.

From the state of the art a further target informing system is known. U.S. Pat. No. 6,133,851 discloses a truck light warning system for automatically alerting a driver near a truck that they are either following too closely or are within the truck's blind spot. For that, the inventive system comprises a plurality of sensors arranged at the blind spots of the truck for sensing an object entering the blind spot zone, and indicators indicating a warning upon detection of an object within the blind spot zone.

Disadvantageously, the equipment with sensors and indicators is very expensive and since all necessary parts of the system need to be electrically connected, the retrofitting of existing system with the described system is often not possible.

It is therefore desirable to provide a blind spot warning device and system which is both precise and easy to arrange at, attach to, or integrate into a vehicle.

The invention, according to an aspect thereof, is based on the idea to provide a blind spot warning device which is only perceptible for a target object in a certain relative position to a host vehicle, particularly only if the target is within or close to the blind spot zone of the host vehicle.

Thereby, the blind spot warning device comprises a warning sign, symbol, text, or other device, arranged or arrangeable at the host vehicle exterior which is perceivable for a target only when the target is within or close to the blind spot of the host vehicle. The warning would thus cease when the target is no longer within or close to the host vehicle's blind spot.

The primary difference of the invention compared to existing, static warning signs is that the current invention only warns when the target object is in or very close to the blind spot zone. The advantage of this is twofold. First, the fact that something is changing in the warning device draws attention to the warning sign (or similar) and therefore, there is a greater chance that the driver in the target vehicle actually will notice the warning as opposed to if the warning was constantly visible and/or constantly audible. Second, by adding the relative position dependence, the drivers in target vehicles get a more intuitive understanding of where the blind spot zones start and end.

For example, in case a truck is the host vehicle and a passenger car is the target vehicle, the blind spot warning device is adapted to be not perceptible by the driver (target object) in the passenger car when the truck driver can see the passenger car in the truck's side mirrors. As the car enters or approaches the truck's side blind spot, the warning becomes perceivable by the passenger car driver who then becomes aware of the potentially hazardous situation and can take evasive action (i.e. pass the truck or slow down until the warning is no longer is perceptible for him).

Although the above example deals with the truck vs. car situation, the invention would be applicable to other types of situations and host vehicles as well, such as buses, cars, construction equipment and trains.

Further, the blind spot warning device may be adapted to inform a target object not only when the target object enters the blind spot zone, but also when the target object is approaching a blind spot zone. Advantageously, a target object may take countermeasures for avoiding the blind spot zone at an early stage, preferably even before the target object has entered the blind spot zone. Thereby, a hazardous situation due to the being in a blind spot may be avoided. The pre-warning may be realised by e.g. a change in colour, change in brightness, change in loudness, change of message etc. of the warning information perceived by the target object

Further it should be noted that a host vehicle can be equipped with more than one type of blind spot warning devices. Advantageously, a target object's attention can be stimulated and guided by different warnings when approaching or being within the blind spot zone whereby it is ensured that the target object is in fact aware of the blind spot zone of the host vehicle.

According to a first aspect of the invention, the blind spot warning device is arranged or arrangeable at the host vehicle's exterior comprising a warning indicating at least one blind spot of the host vehicle to a target object being outside the host vehicle, wherein the warning is only perceptible for the target object in dependence on the target object's viewpoint of the host vehicle. The blind spot warning device may be an individual device which is attachable to the host vehicle, or the blind spot warning device may already be integrated into the host vehicle e.g. during manufacturing, particularly during a painting or assembling process.

Advantageously, the blind spot warning device is calibrated to the host vehicle's blind spot boundaries so that the warning is only perceptible if the target object is within or close to the zone of the blind spots of the host vehicle.

According to a further preferred embodiment, the device is an optical device adapted to show at least one image depicting a blind spot warning if the target object is within or close to the zone of the at least one blind spot of the host vehicle. As mentioned above, the sudden appearance of a warning draws attention to the warning sign so that there is a greater chance that the driver in the target vehicle will notice the warning as opposed to if the warning was constantly visible. Further due to the position dependence, the drivers in target vehicles get a more intuitive understanding of where the blind spot zones start and end.

According to a further preferred embodiment, the blind spot warning device is adapted to show at least two different images, wherein it depends on the viewpoint of the target object which image is visible.

According to a further preferred embodiment, the position dependent perceptibility of the warning may be based on lenticular technology, wherein preferably the device comprises a plurality of, preferably semicircular, lenses, wherein the lenses are adapted to direct light to one of the images dependent on the target's relative position to the host vehicle.

According to a further preferred embodiment, the position dependent perceptibility of the warning may be based on holographic technology, wherein preferably the relative position of the target determines light amplitude and light phase reflected by the blind spot warning device so that one of the images is shown.

Advantageously, these blind spot warning devices provide a possibility to direct the target object's attention to the information, namely the warning, provided on them. This is due to a change in the appearance of the device when the target object approaches, enters or leaves the blind spot zone. If, additionally, the information or the warning is self-explaining, e.g. by showing the text “blind spot” when the target object is in the blind spot zone, the boundaries of the blind spot zone are intuitively communicated to the target object.

According to a further preferred embodiment, the position dependent perceptibility of the warning may be based on at least one light obstructing element obstructing the view onto the image if the target object is outside the zone of the at least one blind spot of the host vehicle. This light obstructing element may be a microlouver layer, wherein the microlouver layer comprises miniature opaque louvers, preferably integrated in a transparent film. The miniature opaque louvers obstruct the light reflected by the blind spot warning device from reaching other angels than those which refer to the blind spot zones.

Alternatively or additionally, the light obstructing element is at least one blind, preferably arranged at the circumference of the device, obstructing the view onto the image if the target object is outside the zone of the at least on blind spot of the host vehicle.

According to a further preferred embodiment, the at least one light obstructing element is mechanically and/or electrically adjustable for calibrating to the host vehicle's blind spot boundaries, wherein preferably the blinds and/or microlouvers are adjustable.

Thereby, different blind spot angles may be applied, so that an accurate determination of the blind spot zone is possible. Different blind spot angles and thereby also a different blind spot zones may arise e.g. at different lane widths.

According to a further preferred embodiment, the blind spot warning device is a passive decal, which is, preferably adhesively or magnetically, attachable to the vehicle's exterior.

Advantageously, the decal may be made from a fluorescent material and/or a reflective material and/or a phosphorescent material and/or a chemoluminescent material. By using these kinds of materials, a perceptibility of the warning device is also given during night time. Additionally, during day time, the perceptibility is enhanced.

According to a further preferred embodiment, the warning device is illuminatable, preferably from its backside. This also enhances the perceptibility of the warning device. Advantageously, for illuminating the warning device, a lamp and/or an LED, preferably an LED backlight, and/or an electroluminescent element, such as an electroluminated sheet, electroluminated panel and/or electroluminated wire is used. These illumination devices provide an energy saving illumination and are relatively flat so that the blind spot warning device does not become bulky.

According to a further preferred embodiment, the blind spot warning device is a computer display. For providing the position dependent perceptibility, the computer display may be equipped with a so called privacy filter, which may be realized by a microlouver layer, placed on the surface of the display.

For saving energy, it is advantageous if the device is further adapted to be controlled such that the illumination of the decal or an activation of the computer display is performed only upon detection of a target object entering or approaching the zone of the at least one blind spot of the host vehicle. Further, it is also possible to control the illumination of the blind spot warning device so that the illumination flashes in order to further increase the attention of the target object to the blind spot warning device.

Alternatively and/or additionally, the blind spot warning device may comprise an acoustic device which is adapted to direct an auditory alert which is only audible for a target object, if the target object is within or close to the zone of the at least one blind spot. This sound directing is possible by applying a technology using specially arranged loudspeakers, preferably by an ultrasonic parametric array. An ultrasonic parametric array, such as known as “Audio Spotlight”, is a technique where an array of ultrasonic transducers is used to produce audible sound with very high directivity. In this technique, the transducers project a narrow beam of modulated ultrasound that is powerful enough (100 to 110 dB) to substantially change the speed of sound in the air that it passes through. The air within the beam then behaves nonlinearly and extracts the modulation signal from the ultrasound, resulting in sound that can be heard only along the path of the beam. The basics of this technology are described at http://www.holosonics.com/tech directivitv.html.

Another possibility for providing an acoustic blind spot warning is for example to use directional loudspeakers the directionality of which is based on the electrostatic principle. This technology is also known as “sound shower”. High directivity is in this case achieved by having a transducer (a loudspeaker) which has an area which is large in comparison to the wavelength of the sound it emits. The electrostatic principle is especially suitable for constructing loudspeakers which both are flat and have a large area. Further information is given by Panphonics Directional Speakers Sound Shower, available at http://www.panphonics.com/directional-speakers.html.

A further preferred embodiment uses a loudspeaker phased array where traditional loudspeakers are used which are controlled by a digital signal processing technology and provide an adjustable beam of sound. The focused speaker arrays consist of multiple small, high quality loudspeakers contained in a very thin, unobtrusive unit providing good sound quality and directional audio control. In this technique, a special device (usually a Digital Signal Processor—DSP) controls the phase (or time delay) and relative amplitude of the signal sent to each loudspeaker, in order to create a pattern of constructive and destructive interference in the wave front which results in a narrow main lobe. For further information, please refer to http://dakotaspeaker.com/.

According to another preferred embodiment a so called “sound Dome” may be used. This is a parabolic loudspeaker providing a directed sound. Using this technique, one or more loudspeaker drivers are mounted at the focal point of a parabola pointing away from the receiver, toward the parabolic surface. The sound is bounced off the parabolic dish and leaves the dish focused in plane waves. Further information is available at http://www.browninnovations.com/sound domes.html.

As mentioned above, also the acoustic blind spot warning device may further be adapted to be controlled such that an activation of the warning is performed only upon detection of a target object entering or approaching a blind spot zone. For providing such a control a controller and detector as explained below with reference to the blind spot object detecting system (BSODS) may be used.

According to a further preferred embodiment, the blind spot warning device is individually manufactured for each vehicle or for each vehicle type having substantially similar blind spot zones. Since the allowed blind spot zones are clearly defined—at least in Europe by the Directive 2003/97/EC of the European Parliament and of the Council—the blind spot warning device may be calibrated to the allowable boundaries without measuring the blind spot zones of the vehicle directly. This provides the possibility to manufacture the blind spot decal for each and every type of vehicle and just give detailed information where the decal is to be mounted. Thereby a retrofitting possibility is given, which is available and useable for all vehicles without visiting a work shop. Thus, it is for example possible to sell blind spot warning devices at a gas station and that the driver can mount the freshly bought decal to the vehicle all by himself. This in turn may increase the acceptance and the dissemination of such devices, which in turn may increase the safety on the streets.

According to a further preferred embodiment, the calibration to the blind spot boundaries of the host vehicle is performed once during fitting up of the host vehicle.

According to a further preferred embodiment, the calibration is performed, manually or automatically, if a change in the blind spot boundaries of the host vehicle is to be expected, particularly dependent on a change in a lane width the vehicle is travelling on. Thereby, the warning devices can be individually and continuously be adapted to different driving situations.

According to a further preferred embodiment, the vehicle is a vehicle-trailer-combination, particularly a truck trailer combination, and the calibration is performed, manually or automatically, if the vehicle-trailer-combination changes.

According to a further aspect of the invention, a blind spot warning system for a host vehicle is disclosed which comprises at least one detector for detecting a target object within or close to the host vehicle's blind spot zone and a blind spot warning device as described above, wherein preferably the blind spot warning system further comprises a controller which is adapted to control the blind spot warning device to be perceptible when a target object is detected to be within, or close to or within, the host vehicle's blind spot zone.

According to a further preferred embodiment, the at least one detector comprises at least one sensor, particularly a camera, and/or a radar sensor, for detecting an object.

A system comprising a detector for detecting a target object entering a blind spot zone and the controller for issuing a warning upon detection of a target object entering the blind spot zone is named a blind spot object detection system (BSODS) in the following.

According to a further aspect of the invention, the blind spot warning device may be a mechanical device, which is controlled by the blind spot object detecting system to be on display upon detection of an object within the host vehicle's blind spot zone. This mechanical device may be a mechanical arm with a warn sign, which extends or pops out upon detection of an object within the host vehicle's blind spot zone.

According to a further aspect of the invention, a blind spot warning system for a host vehicle is disclosed comprising a blind spot object detecting system for detecting a target object within the host vehicle's blind spot zone wherein the target object comprises an internal interface which is adapted to receive a signal from an outside source, and the blind spot warning system is adapted to transmit a warning signal to the target object's internal interface upon detection of the target object being within the host vehicle's blind spot zone. This has the advantage, that a driver can be directly informed by means of e.g. a driver assistance system, which also reduces the possibility of disregard of the blind spot warning.

According to a further preferred embodiment, the target object is a vehicle and the target objects internal interface is at least one of an information display, a tell-tale light, a sound system and a driver assistance system, whereby preferably at least one of an audio, visual and tactile warning can be issued.

According to a further preferred embodiment, the blind spot warning system is adapted to transmit a warning signal to the target object's interface by means of a wireless computer network for traffic safety, a global position system, a radio data system or similar.

Preferably, the vehicle is a truck, a car, a bus, a construction equipment, an agricultural equipment, a train, or a ship. However, the vehicle can also be a vehicle-trailer-combination, such as a truck-trailer-combination, a car-trailer-combination, particularly a car-caravan-combination, a bus-trailer-combination, particularly a bus-coach-combination, or a construction of an agricultural equipment towing a trailer or a tool.

As mentioned above also the actively illuminated and/or the acoustic blind spot warning device may be controlled by the blind spot object detecting system (BSODS). When a target object (another vehicle, pedestrian, cyclist etc) is detected by the BSODS (by means of cameras, radars or other sensing equipment and related processing units) within or close to the vehicle's blind spot zone, the blind spot warning device is activated informing the target object of the hazardous situation.

According to a further preferred embodiment, the blind spot warning system comprises a BSODS as described in the previous paragraph but the warning signal is additionally sent directly to the target object's internal interface (information displays, tell-tale lights, sound system etc) when the target object is within or close to the host vehicle's blind spot. This can be accomplished by means of a wireless computer network for traffic safety, Global Positioning System (GPS)/Differential GPS (DGPS), Radio Data System (RDS) or similar.

Further, the blind spot warning system may also comprise a passive viewpoint-dependent decal, as described above, arranged at the host vehicle exterior which is calibrated to the host vehicle's blind spot boundaries to show the blind spot warning sign when the target object is within or close to the host vehicle's blind spot.

According to a further preferred embodiment, the blind spot warning system comprises a lamp/LED or an array or lamps/LEDs which are made viewpoint-dependent by means of small screens which obstruct the light from reaching other angles than those which constitute the blind spot zone. The screens could also be (electro-) mechanically adjustable to provide calibration means of the warning zone or to accommodate different blind spot angles (which may be a result of varying lane widths).

Even if not described in detail above, each of the blind spot warning devices may be present alone or in combination with at least one of the other blind spot warning device described herein. For example, it is possible to equip a host vehicle with a passive blind spot warning decal described above and in addition provide an active warning to the target vehicle by means of a message sent directly into the target vehicle as described above. In another embodiment the passive blind spot warning decal may be combined with the acoustic warning device described above. In a third embodiment, the host vehicle can be equipped with said passive blind spot warning decal and with said acoustic warning device and, in addition, provide an active warning to the target vehicle by means of a message sent directly into the target vehicle.

Further advantages and preferred embodiments are defined in the claims, the figures and the description.

### BRIEF DESCRIPTION OF THE DRAWINGS

In the following, the invention will be discussed with help of the attached Figures. The description thereof is considered as exemplification of the principles of the invention and is not intended to limit the scope of the claims.

The Figures show:

FIG. 1: a schematic illustration of the blind spot zones of a truck-trailer-combination:

FIG. 2: a schematic illustration of a preferred embodiment of the invention;

FIG. 3: a schematic illustration of a further preferred embodiment of the invention indicating only a blind spot warning zone;

FIG. 4: a schematic illustration of the preferred embodiment shown in FIG. 4 indicating a blind spot warning zone and a blind spot pre-warning zone; and

FIG. 5: a schematic cross section view of a preferred embodiment of the inventive blind spot warning device.

### DETAILED DESCRIPTION

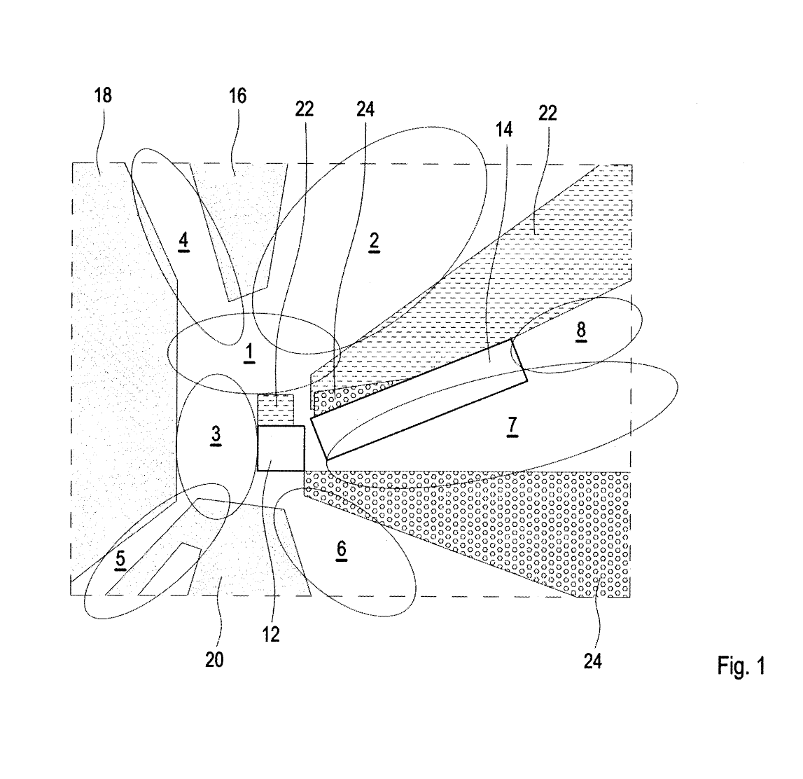

FIG. 1 shows a schematic top view of a vehicle comprising a driver's cabin 12 and a trailer 14. Usually, a driver can directly observe his environment through the windscreen and the side windows of the driver's cabin 12. Thereby, areas 16, 18 and 20 are directly visible for the driver. Indirectly through mirrors (not shown), the areas indicated by reference signs 22 and 24 are also visible for the driver. However, there remain a number of blind spot zones 1 to 8, which are not, neither directly nor indirectly, observable for the driver.

While additional mirrors can increase the driver's field of view, this solution can have negative aerodynamic effects and also increase the complexity of the driver interface. Moreover, mirrors are difficult to adjust and wide angle mirrors provide only distorted views of the surrounding traffic.

Active systems which detect and warn the driver for objects present in the blind spots may be another solution to the problem. However, this still does not solve the key problem which in many blind spot accidents is that the person in the blind spot (target) is not aware of that he cannot be seen by the driver (host). It is easy to avoid being in the blind spots of host vehicles simply by passing the host vehicle or letting the host vehicle pass—what is more difficult however is realizing that one is in a blind spot.

The current invention aims at resolving the blind spot problem by warning surrounding road users as they enter a blind spot zone by means of a warning device (sign or similar) attached to the host vehicle exterior, which is only perceptible dependent on the position of the target object relative to the host vehicle.

Preferably, the blind spot warning device according to the invention comprises a warning sign, symbol, text, or other device, arranged at, attached to or integrated into, the host vehicle exterior which is perceivable for a target only when the target is within or close to the blind spot of the host vehicle. The warning would thus disappear when the target is no longer within the host vehicle's blind spot.

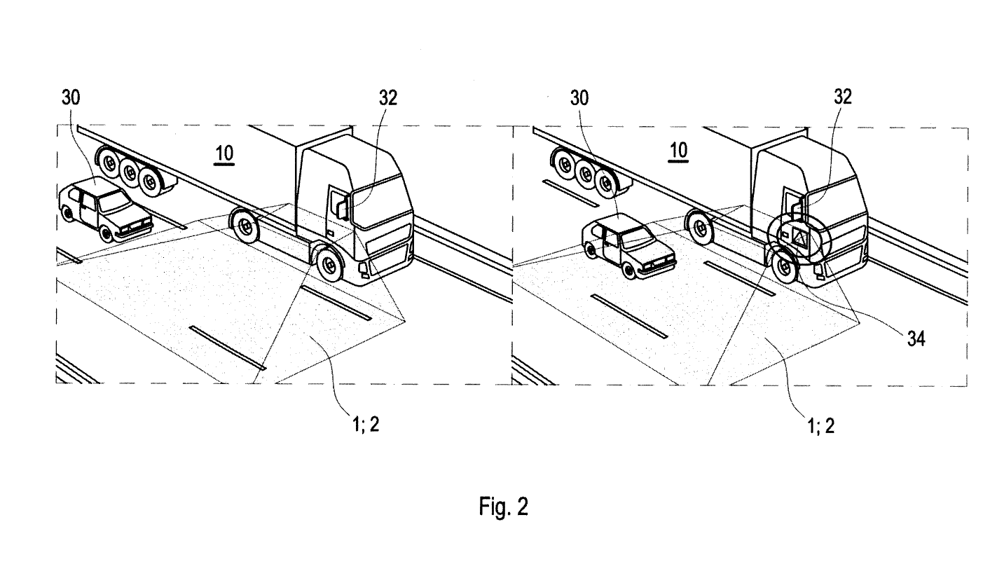

A visualization of how this works is shown in FIGS. 2, 3 and 4. In FIG. 2, a truck 0 is the host vehicle and a passenger car 30 is the target vehicle. When the truck driver can see the passenger car 30 in the truck's side mirrors 32 (left panel, FIG. 2), a warning sign 34, namely the warning indicated on the blind spot warning device (depicted only in the right panel of FIG. 2), cannot be seen by the driver in the passenger car 30. As the car 30 enters the truck's side blind spot zone 1; 2, the warning sign 34 becomes perceivable by the driver of the car 30 as can be seen on the right panel in FIG. 2. The driver of the car 30 then becomes aware of the potentially hazardous situation and can take evasive action (i.e. pass the truck or slow down until the warning sign 34 is no longer visible for him).

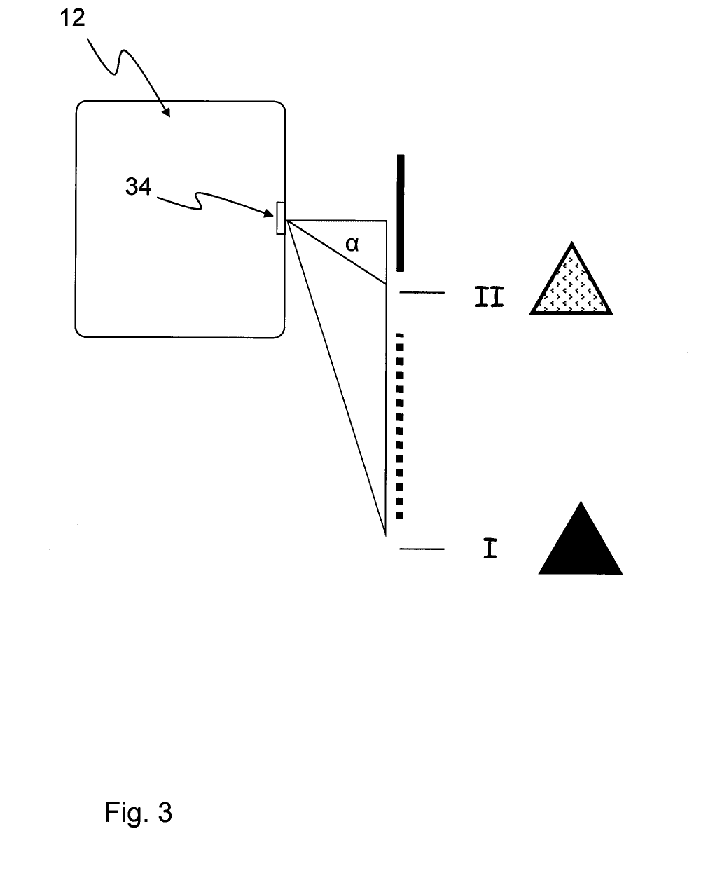

FIG. 3 depicts the same situation as in FIG. 2, only viewed from above. At a first stage I (left panel of FIG. 2), the warning sign is not perceptible for the driver of the target vehicle. The blind spot warning device 34 may e.g. appear as black sign or a sign in the colour of the host vehicle.

As the driver of the target vehicle approaches the blind spot zone and subsequently crosses the boundary given by angle a at stage II, the blind spot warning device 34 becomes perceptible (see also left panel of FIG. 2), depicting e.g. the message “blind spot” or appear as a red sign.

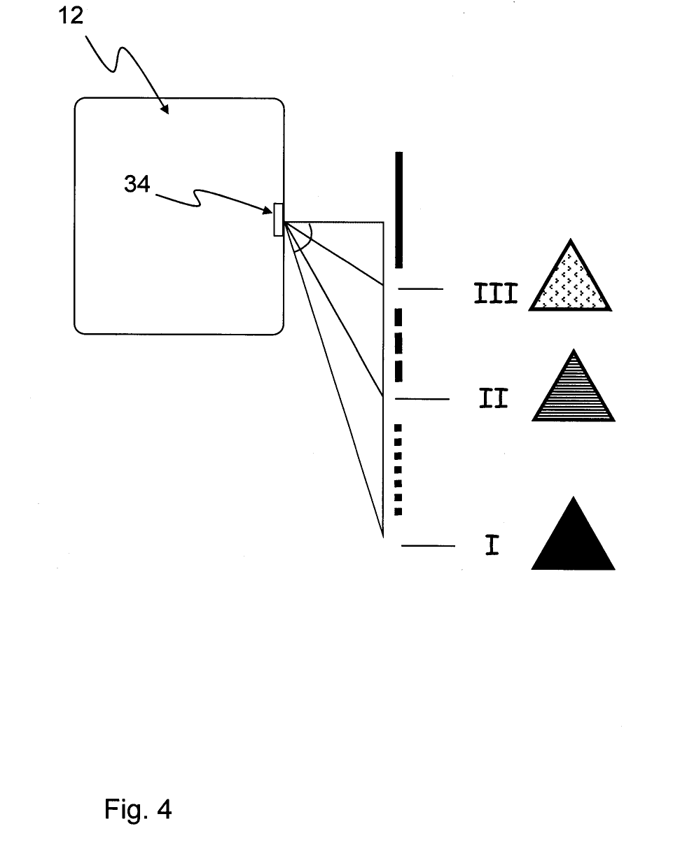

Instead of warning the driver of the target vehicle only if he is crossings the boundary to the blind spot warning, it is also possible to pre-warn the driver by informing him that he is approaching a blind spot zone. Such an embodiment is schematically illustrated in FIG. 4.

In this depicted embodiment, the blind spot warning device 34 is not perceptible to the driver of the target vehicle in stage I, as already described in relation to FIGS. 2 and 3. As the driver of the target vehicle approaches the blind spot zone he is informed by the blind spot warning device 34 of this approach by a pre-warning (see stage II). If the driver continues approaching and finally enters the blind spot zone, the blind spot warning device 34 changes again and shows the blind spot warning (see stage III).

This change of warning may be performed by e.g. changing colour (e.g. from black to yellow to red), by changing message (no message, pre-warning message, warning), changing brightness (dark, semi-dark, bright), or in case of an acoustic device by changing loudness (silent, normal, loud). Preferably, the boundaries are sharply defined so that a sudden change of the warning draws the driver's attention to the blind spot warning device. However, it is also possible to gradually change the appearance or loudness of the blind spot warning device, e.g. by fading in.

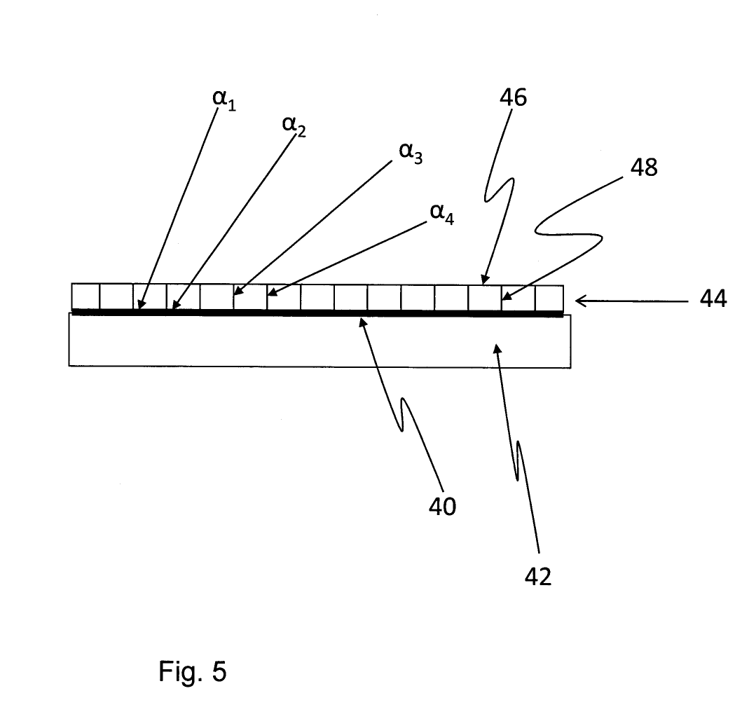

FIG. 5 depicts a sectional view through a preferred embodiment of an inventive blind spot warning device. In this embodiment, the blind spot warning device comprises a decal 40, which is preferably adhesively or magnetically attachable or laminatable to the vehicle, e.g. to the truck driver's door 42 as shown in FIG. 2. On the top surface of the decal 40 a microlouver layer 44 is applied, which comprises a transparent film 46 and opaque miniature louvers 48 integrated into the transparent film. The opaque miniature louvers 48 may be constituted by an opaque layer (preferably having the same colour as the truck) which is laminated between transparent plastic strips. The distance between the miniature louvers 48 and the thickness of the film 46 determine the light obstructing angle a.

For example, for a target object viewing the decal 40 from angles α1 and 02 the image on the decal 40 is visible. Thereby the angles α2 and a₂ correspond to the blind spot angles, so that the image on the decal 40 is only visible if the target object is within or close to the blind spot zone of the vehicle. At more acute angles such as a₃ and a₄, the decal 40 becomes invisible due to the opaque layer of the miniature louvers 48.

Preferably, the thickness of the film 46 is only a few millimeters, so that the overall dimension of the blind spot warning device remains quite flat.

As mentioned above, blind spot accidents are very common and e.g. truck drivers encounter blind spot situations daily. It is therefore of great interest for e.g. truck manufacturers and haulage companies to endorse a technology which attempts to solve the blind spot problem. The above described embodiments involve rather simple, passive technologies and are therefore inexpensive to develop and mass produce which would result in a low price for Original Equipment Manufacturers (OEMs) and end customers. Such solutions also mean that the warning device would easily integrate both in the production state of a vehicle and as a retro-fit option.

Even if some of the above described embodiments are more technically complex and require that a BSODS is installed in the target vehicle or supplied with the warning device, they provide a novel and efficient solution to the blind spot problem. These embodiments are particularly suitable for new manufactured vehicles.

1. Blind spot warning device arranged or arrangeable at a host vehicle's exterior comprising a warning indicating at least one blind spot of the host vehicle to a target object being outside the host vehicle, wherein the warning is a visual warning which is only perceptible for the target object in dependence on the target object's relative position to the heist vehicle, whereby the device is calibrated to the host vehicle's blind spot boundaries so that the warning is only perceptible if the target object is within or close to the zone of the at least one blind spot of the host vehicle.

2. Blind spot warning device according to claim 1, wherein the device is further adapted to inform the target object of an approach to the at least one blind spot zone by issuing a pre-warning, which is only perceptible if the target object is close to the at least one blind spot zone.

3. Blind spot warning device according to claim 1, wherein the device is adapted to show at least one image depicting a blind spot warning if the target object is within or close to the zone of the at least one blind spot of the host vehicle.

4. Blind sport warning device according to claim 3, wherein at least two different images are depicted, wherein it depends on the relative position of the target object which image is visible.

5. Blind spot warning device according to claim 1, wherein the position dependent perceptibility of the warning is based on lenticular technology.

6. Blind spot warning device according to claim 4, wherein the position dependent perceptibility of the warning is based on lenticular technology, the device comprises a plurality of lenses, and wherein the lenses are adapted to direct light to one of the images dependent on the target object's relative position.

7. Blind spot warning device according to claim 1, wherein the position dependent perceptibility of the warning is based on holographic technology.

8. Blind spot warning device according to claim 4, wherein the position dependent perceptibility of the warning is based on lenticular technology, the device comprises a plurality of lenses, the lenses are adapted to direct light to one of the images dependent on the target object's relative position, and the relative position of the target object determines light amplitude and light phase reflected by the blind spot warning device so that one of the images is shown.

9. Blind spot warning device according to claim 3, wherein the position dependent perceptibility of the warning is based on at least one light obstructing element obstructing the view onto the image if the target object is outside the zone of the at least one blind spot of the host vehicle.

10. Blind spot warning device according to claim 9, wherein the light obstructing element is a microlouver layer.

11. Blind spot warning element according to claim 9, wherein the light obstructing element is at least one blind, arranged at the circumference of the device, obstructing the view onto the image if the target object is outside the zone of the at least on blind spot of the host vehicle.

12. Blind spot warning element according to claim 9, wherein the at least one light obstructing element is mechanically and/or electrically adjustable for calibrating to the host vehicle's blind spot boundaries, wherein the blinds and/or microlouvers are adjustable.

13. Blind spot warning device according to claim 1, wherein the blind spot warning device is a passive decal, which is attachable to the vehicle's exterior.

14. Blind spot warning device according to claim 13, wherein the decal is made from a fluorescent material and/or a reflective material and/or a phosphorescent material and/or a chemoluminescent material.

15. Blind spot warning device according to claim 13, wherein the device is illuminatable from a backside and/or by means of LEOs and/or by means of an electroluminescent element.

16. Blind spot warning device according to claim 1, wherein the device is a computer display.

17. Blind spot warning device according to claim 1, wherein the device further comprises an acoustic device directing an auditory alert so that the auditory alert is only audible for the target object, if the target object is within or close to the zone of the at least one blind spot of the host vehicle.

18. Blind spot warning device according to claim 17, wherein the position dependent perceptibility of the warning is based on ultrasonic transducers array technology.

19. Blind spot warning device according to claim 17, wherein the position dependent perceptibility of the warning is based on a directional loudspeaker.

20. Blind spot warning device according to claim 17, wherein the position dependent perceptibility of the warning is based on a parabolic loudspeaker.

21. Blind spot warning device according to claim 17, wherein the position dependent perceptibility of the warning is based on a loudspeaker phased-array technology.

22. Blind spot warning device according to claim 15, wherein the device is further adapted to be controlled such that an illumination of the decal and/or an activation of the computer display and/or an activation of the acoustic device is performed upon detection of a target object entering or approaching the zone of the at least one blind spot of the host vehicle.

23. Blind spot warning device according to claim 1, wherein the calibration to the blind spot boundaries of the host vehicle is performed once during fitting up.

24. Blind spot warning device according to claim 1, wherein the calibration is performed, manually or automatically, if a change in the blind spot boundaries of the host vehicle is to be expected, particularly dependent on a change in a lane width the vehicle is travelling on.

25. Blind spot warning device according to claim 1, wherein the blind spot warning device is individually manufactured for each vehicle or for each vehicle type having substantially similar blind spot zones.

26. Blind spot warning device according to claim 1, wherein the vehicle is vehicle-trailer-combination, particularly a truck trailer combination, and the calibration is performed, manually or automatically, if the vehicle-trailer-combination changes.

27. Blind spot warning device according to claim 1, wherein the vehicle is a truck, a car, a bus, a construction equipment, an agricultural equipment, a train, a ship, a vehicle-trailer-combination, a car-trailer-combination, a bus-trailer-combination, or a construction of agricultural equipment towing a trailer or tool; and/or wherein the target object is another road user, such as another vehicle, a bicyclist or a pedestrian.

28. Blind spot warning system for being mounted into a vehicle comprising a blind spot warning device according to claim 1 and at least one detector element for detecting the presence of a target object in the zone of the at least one blind spot of the host vehicle, further comprising a controller for controlling the blind spot warning device to be perceptible upon detection of the target object entering or approaching the zone of the at least one blind spot of the host vehicle.

29. Blind spot warning system according to claim 28, wherein the blind spot object detecting system comprises at least one sensor for detecting an object.

30. Blind spot warning system for a host vehicle comprising a blind spot object detecting system for detecting a target object within at least one host vehicle's blind spot zone and a blind spot warning device, wherein the blind spot warning device is controlled by the blind spot object detecting system in order to indicated a warning when a target object is detected to be within the at least one host vehicle's blind spot zone wherein the blind spot warning device is a mechanical device, which is controlled by the blind spot object detecting system to be on display upon detection of an object within the at least one host vehicle's blind spot zone.

31. Blind spot warning system according to claim 30, wherein the mechanical device is a mechanical arm with a warn sign, which extends or pops out upon detection of an object within the host vehicle's blind spot zone.

32. Blind spot warning system for a host vehicle comprising a blind spot object detecting system for detecting a target object within at least one host vehicle's blind spot zone wherein the target object comprises an internal interface which is adapted to receive a signal from an outside source, and the blind spot warning system is adapted to transmit a warning signal to the target object's internal interface upon detection of the target object within the at least one host vehicle's blind spot zone.

33. Blind spot warning system according to claim 32, wherein the target object is a vehicle and the target objects internal interface is an information display, a tell-tale light, a sound system and/or a driver assistance system for providing an audio, visual and/or tactile warning.

34. Blind spot warning system according to claim 32, wherein the blind spot warning system is adapted to transmit a warning signal to the target object's interface by means of a wireless computer network for traffic safety, a global position system, a radio data system or similar.

35. Blind spot warning system according to claim 32, further comprising a blind spot warning device which is a mechanical device, being controlled by the blind spot object detecting system to be on display on the host vehicle upon detection of an object within the at least one host vehicle's blind spot zone, wherein the mechanical device is a mechanical arm with a warn sign, which extends or pops out upon detection of an object within the host vehicle's blind spot zone.

36. Blind spot warning system according to claim 30, wherein the blind spot object detecting system comprises at least one sensor.

37. Blind spot warning system according to claim 30, wherein the host vehicle is further equipped with at least one blind spot warning device according to any one of claims 1 to 29.

38. Vehicle having a blind spot warning device according to claim 1.
